(19) United States
(12) Patent Application Publication
(10) Pub. No.: US 2019/0393771 A1
(43) Pub. Date: Dec. 26, 2019

(54) VOLTAGE CONTROLLED CURRENT INPUT AND TRANSIMPEDANCE REGULATOR

(71) Applicants: Mykhaylo Teplechuk, San Diego, CA (US); Taner Dosluoglu, New York, NY (US)

(72) Inventors: Mykhaylo Teplechuk, San Diego, CA (US); Taner Dosluoglu, New York, NY (US)

(21) Appl. No.: 16/451,534

(22) Filed: Jun. 25, 2019

Related U.S. Application Data
(60) Provisional application No. 62/689,684, filed on Jun. 25, 2018.

(51) Int. Cl. H02M 1/088; H02M 3/158

(52) U.S. Cl. CPC H02M 1/088; H02M 2001/0048; H02M 3/158

(57) ABSTRACT

A transimpedance regulator may include a switched capacitor converter, with a current input and a regulated voltage output. A DC-DC switching converter with an inductive component may be used as a current source for the switched capacitor converter. In some embodiments the DC-DC switching converter with an inductive component may be operated in a manner expected to provide optimum power efficiency, with the switching capacitor converter providing a desired regulated voltage output.

### CROSS REFERENCE TO RELATED APPLICATION

This application claims the benefit of the filing date of U.S. Provisional Patent Application No. 62/689,684, filed on Jun. 25, 2018, the disclosure of which is incorporated by reference herein.

### BACKGROUND OF THE INVENTION

The present invention relates generally to power management for semiconductor devices, and more particularly to use and operation transimpedance regulators in semiconductor power management devices.

Integrated circuits generally require provision of power within particular parameters during operation. The provision of such power may face many complexities. For example, semiconductor chips including the integrated circuits may have different portions that require power at the same or different times, different portions may require power within different parameters, and some portions may utilize different amounts of power at different times. This may be particularly true for those chips integrating multiple components that may be considered a system-on-chip (SOC). Complicating matters, some devices may be powered by batteries having relatively small capacities, while the devices themselves, at least at various times, may require large amounts of power.

Further complicating matters, while battery technology may remain relatively unchanged for mobile devices and the like, typically supplying voltage in the 2.8V-4.5V range for example, supply voltage levels for operation of the integrated circuits of SOCs has generally been steadily reducing. Similarly, while servers and industrial applications may make use of new SOCs, legacy rack supply voltage arrangements, typically 12V, generally remain unchanged. Provision of power at voltage levels significantly lower than supply voltage levels may result in increased power losses as the voltage level is stepped down.

Design and control of voltage regulators for such applications may therefore pose difficulties.

### BRIEF SUMMARY OF THE INVENTION

Some embodiments in accordance with aspects of the invention provide a voltage regulator with a voltage controlled current source coupled to a transimpedance regulator.

Some embodiments in accordance with aspects of the invention provide a DC-DC converter, comprising: a current source, and a transimpedance regulator coupled to an output of the current source. In some embodiments the current source comprises a switching converter with an inductive component, and the transimpedance regulator comprises a switched capacitor converter. In some embodiments the switching converter with an inductive component comprises a high side switch and a low side switch coupled in series between an input voltage and a lower voltage, an inductor having a first end coupled to a node between the high side switch and the low side switch and having a second end coupled to the switched capacitor converter, and a controller configured to operate the high side switch and the low side switch based on a comparison of a voltage feedback signal from the switched capacitor converter and a reference voltage, the reference voltage being an output voltage of the switching converter with the inductive component expected to yield highest conversion efficiency for the switching converter with the inductive component.

These and other aspects of the invention are more fully comprehended upon review of this disclosure.

### BRIEF DESCRIPTION OF THE FIGURES

FIG. 1 is a semi-block diagram, semi-schematic of an input current source driven transimpedance regulator coupled to a load, in accordance with aspects of the invention.

FIG. 2 is a semi-block diagram, semi-schematic showing a switched DC-DC inductive component converter serving as an input current source driving a transimpedance regulator, in accordance with aspects of the invention.

FIG. 3 is a semi-block diagram, semi-schematic illustrating design aspects of a switched DC-DC inductive component converter for use in driving a transimpedance regulator, in accordance with aspects of the invention.

FIGS. 4A and 4B are semi-schematics of a voltage regulator in accordance with aspects of the invention.

FIGS. 5A, 5B, and 5C are schematics of a voltage regulator with a step down converter having an offset voltage capability, in accordance with aspects of the invention.

FIG. 6 is a block diagram of a further voltage regulation system in accordance with aspects of the invention.

### DETAILED DESCRIPTION

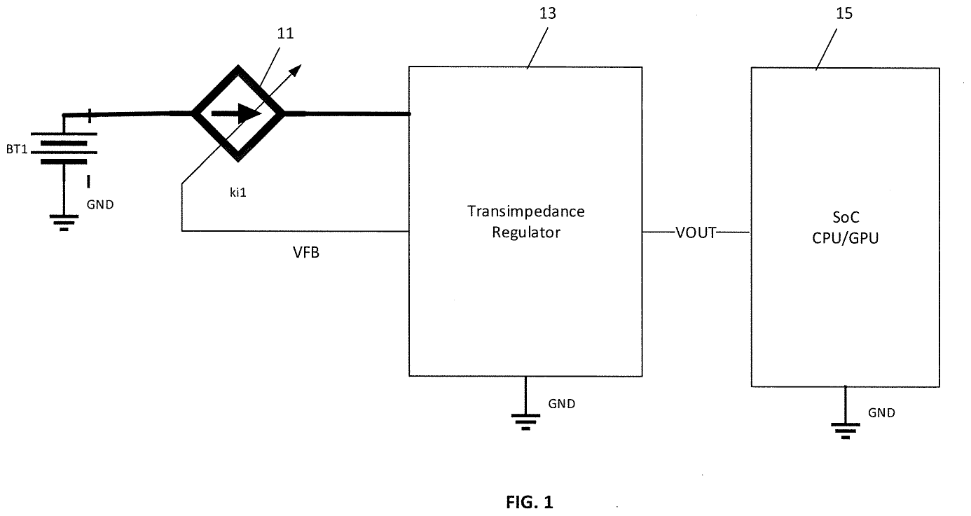

FIG. 1 is a semi-block diagram, semi-schematic of an input current source driven transimpedance regulator coupled to a load, in accordance with aspects of the invention. In FIG. 1, a current source 11 provides a current to a transimpedance regulator 13. The transimpedance regulator provides power at a voltage Vout to a load 15, with the load being shown as a system-on-chip (SoC) processor, such as a CPU or GPU.

In some embodiments the current source is a voltage controlled current source. In some such embodiments, and as illustrated in FIG. 1, the current source is controlled using a voltage feedback signal from the transimpedance regulator. The voltage feedback signal may be voltage of the output of the transimpedance regulator, Vout, or, in some embodiments, voltage of an internal node of the transimpedance regulator. In some embodiments the current source is designed to provide output at a nominal operating voltage, Vnom, with a difference between a voltage level of the voltage feedback signal and Vnom used to control output current of the current source.

In some embodiments the transimpedance regulator comprises a DC-DC switched capacitor converter, with a current input and voltage output. The switched capacitor converter generally upconverts or downconverts its input voltage to selected ratios of the input voltage through coupling of capacitors within the switched capacitor converter to provide a desired voltage conversion ratio. In embodiments in which the input voltage is set to Vnom, the output voltage of the switched capacitor converter may be set as Vout=K(t)*Vnom, with K(t) being the selected capacitor ratio. In some embodiments the selected capacitor ratio may be selected based on a signal indicating a desired output voltage, for example a dynamic voltage frequency scaling signal from the SoC or other controller.

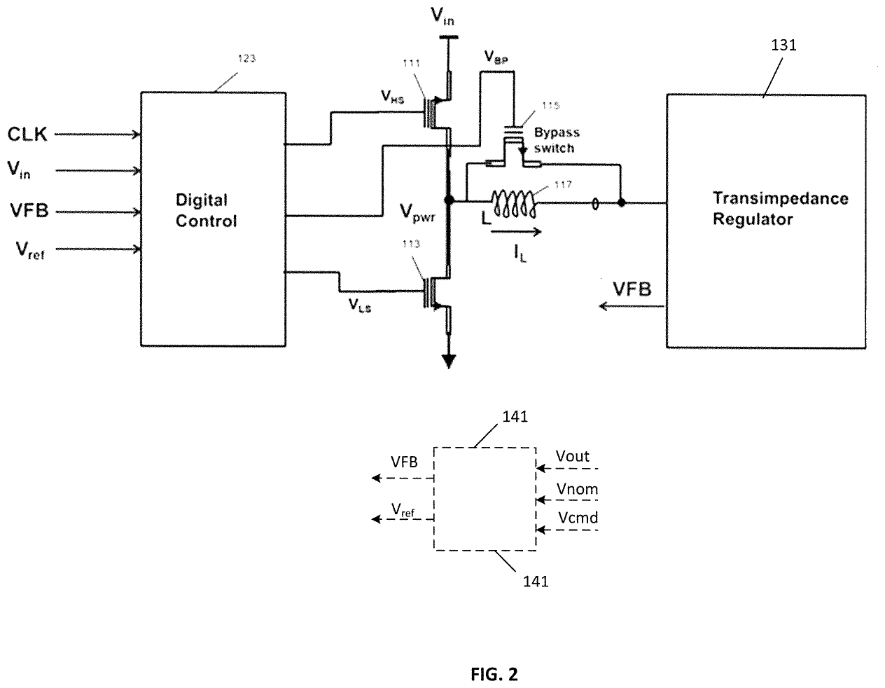

In some embodiments the current source is a switching converter with an inductive component. FIG. 2 is a semi-block diagram, semi-schematic showing a switched DC-DC inductive component converter serving as an input current source driving a transimpedance regulator, in accordance with aspects of the invention. As shown in FIG. 2, a pair of switches, a high side switch 111 and a low side switch 113, are coupled in series between an input voltage and a lower voltage. In many embodiments the input voltage is a supply voltage, for example provided by a battery, and in some embodiments the lower voltage is ground. In this regard, it is noted that various of the figures show a connection to ground. It should be recognized that in many embodiments such connections are to some other voltage level (lower than a higher voltage level), and the some other voltage level may be V_{SS} (with for example a higher voltage level considered V_{DD}). A first end of an inductor 117 is coupled to a node between the high side switch and the low side switch. A second end of the inductor is coupled to a transimpedance regulator 131. In various embodiments the transimpedance regulator is a switched capacitor converter, with at least one capacitor always coupled to ground during operation. The switching converter with an inductive component of FIG. 2 therefore generally has a buck converter topology. In addition, FIG. 2 also shows a bypass switch 115 coupling the first end and the second end of the inductor. Some embodiments of the switching converter with an inductive component include such a bypass switch, but the bypass switch is optional, and not present in some embodiments.

A controller 123 controls operation of the high side switch and the low side switch (and the bypass switch if present). The controller controls the switches based on a voltage feedback signal from the transimpedance regulator and a reference signal, with in some embodiments the reference signal indicative of a Vnom voltage, as discussed with respect to FIG. 1, and in some embodiments the reference signal is indicative of some other desired voltage. In some embodiments the voltage feedback signal is indicative of voltage input to the transimpedance regulator. In some embodiments the voltage feedback signal is indicative of an output voltage of the transimpedance regulator, or a scaled version of the output voltage of the transimpedance regulator. In some embodiments the scaled version of the output voltage of the transimpedance regulator is scaled by a value indicative of a ratio by which the transimpedance regulator steps up or steps down its input voltage. In various embodiments the controller operates the switches using pulse width modulation (PWM) and/or pulse frequency modulation (PFM).

In some embodiments an optional processing block 141 determines the voltage level of the voltage feedback signal. In such embodiments, for example, the processing block may determine a voltage of the voltage feedback signal, and/or the reference signal, based on an output voltage provided by the transimpedance regulator and Vnom. In some such embodiments the processing block may also make use of voltage level for the load as commanded by, for example, a DVFS block of the SoC.

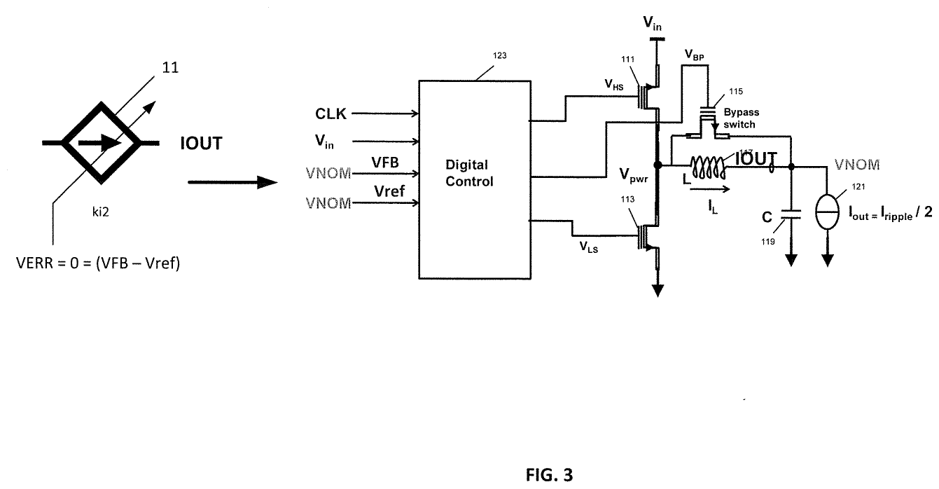

In some embodiments Vnom is determined based on a desired output voltage from the transimpedance regulator and the capacitor ratio(s) of the transimpedance regulator. In some embodiments Vnom is determined based on operating efficiency of the current source. FIG. 3 is an example semi-block diagram, semi-schematic illustrating design aspects of a switched DC-DC inductive component converter for use in driving a transimpedance regulator, in accordance with aspects of the invention. The example of FIG. 3 may be useful in determining Vnom for a switching inductive component converter.

FIG. 3 shows the voltage controlled current source with a control signal set to indicate no adjustment is appropriate for output current of the current source. Example circuitry for such an implementation is also shown in FIG. 3, in the form of a switched DC-DC inductive component converter, with an output capacitor 119 included for descriptive purposes.

The switched DC-DC inductive component converter is as discussed with respect to FIG. 2, with the control block 123 controlling states of the high side switch 111, the low side switch 113, and the optional bypass switch 115. The inductor 117 has, as before, a first end coupled to a node between the high side and low side switches. FIG. 3 additionally indicates the output capacitor 119 and the load 121 for descriptive purposes.

In some embodiments the high side and low side switches are to be operated at an optimum duty cycle expected to yield highest conversion efficiency for the converter. The optimum duty cycle for a particular implementation may vary somewhat based on the process technology and physical size of the particular implementation, but in most implementations the optimum duty cycle is a 50% duty cycle, or close to a 50% duty cycle. With a converter such as the converter of FIG. 3 so operated, and with an average load current presumed to have an amplitude equal to half of the amplitude of peak-to-peak inductor ripple current (which may also be considered an optimum load current), Vnom may be determined.

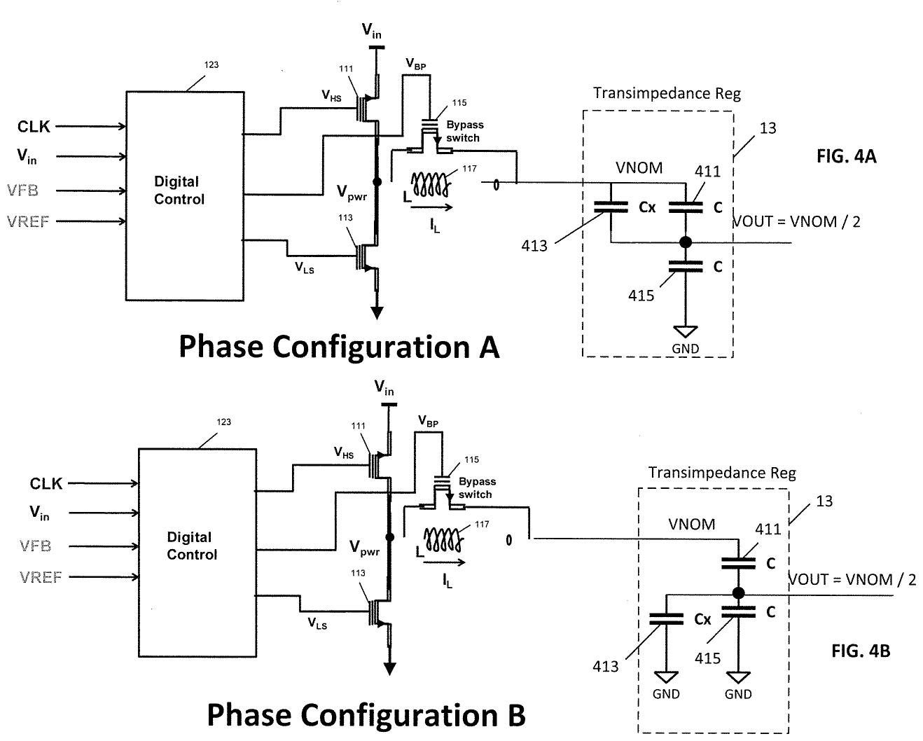

FIGS. 4A and 4B are semi-schematics of a voltage regulator in accordance with aspects of the invention. The voltage regulator of FIGS. 4A and 4B include a current source, generally in a topology of a buck converter, providing current to a transimpedance regulator 13. The transimpedance regulator of FIGS. 4A and 4B is a multi-phase switched capacitor converter, with FIG. 4A showing the capacitor configuration as configured by switches (not shown) for a first clock phase and FIG. 4B showing the capacitor configuration as configured by switches (not shown) for a second clock phase. The switched capacitor converter of FIGS. 4A and 4B is therefore a two phase switched capacitor converter, which, for the capacitors illustrated, steps down an input voltage by a factor of 2. In various embodiments, however, the switched capacitor converter may step down (or step up) the input voltage by different factors, and the number of phases for the switched capacitor converter may vary. For example, in various embodiments the switched capacitor converter may step down (or step up) an input voltage by some other ratio N, N being a rational or irrational ratio.

Both FIGS. 4A and 4B, as do FIGS. 2 and 3, show the control block 123 controlling states of the high side switch 111, the low side switch 113, and the optional bypass switch 115. The inductor 117 has, as before, a first end coupled to a node between the high side and low side switches. In FIGS. 4A and 4B, however, the switched capacitor converter is in place of the output capacitor of FIG. 3. In accordance with the discussion with respect to FIG. 3, the voltage provided to the switched capacitor is nominally Vnom.

For the switched capacitor converter of FIGS. 4A and 4B, a first capacitor 411 and a second capacitor 415 are coupled in series, with the first capacitor coupled to the second end of the inductor of the converter with inductive component, and the second capacitor coupled to ground. An output of the switched capacitor converter is taken from a node between the first and second capacitors. During the first phase of operation, a third capacitor 413 is coupled in parallel to the first capacitor, and during the second phase of operation the third capacitor, through operation of switches (not shown), is coupled to in parallel to the second capacitor. With such a configuration, and with the switched capacitor converter having a capacitor ratio of ½, output voltage of the switched capacitor converter is nominally Vnom/2.

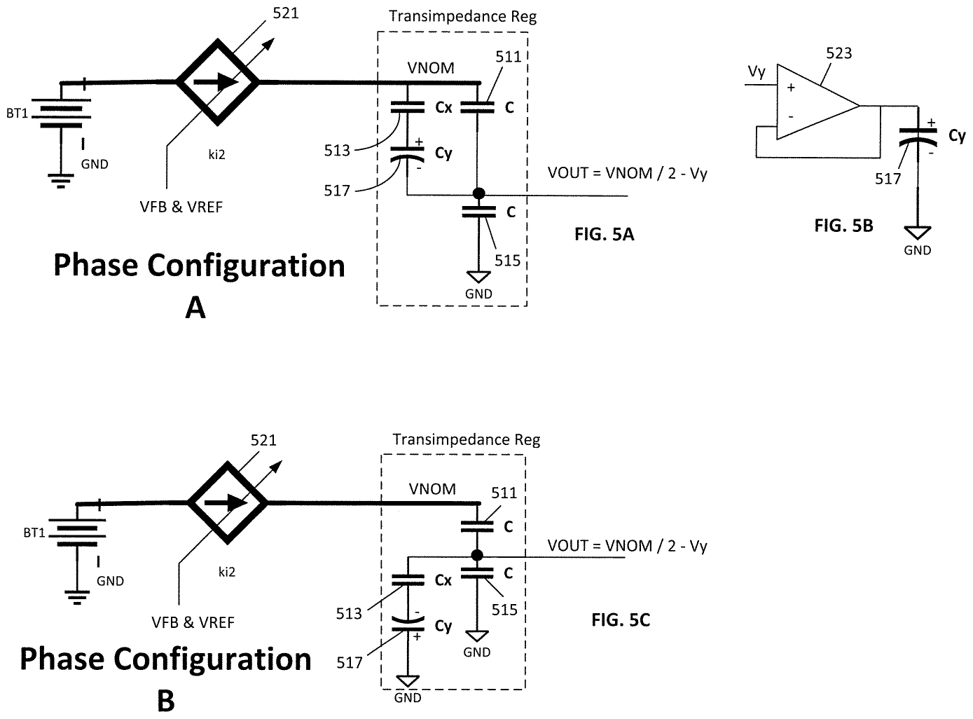

In some embodiments additional regulation is provided for output voltage of the transimpedance regulator. FIGS. 5A, 5B, and 5C illustrate an example of an embodiment of a voltage regulator providing an example of such additional regulation.

As shown in FIGS. 5A and 5B, a voltage controlled current source 521 provides current to a transimpedance regulator at a nominal voltage Vnom. The voltage controlled current source may be, for example, a switched DC-DC converter with an inductive component, for example as discussed herein.

The transimpedance regulator is a switched capacitor converter. For simplicity of discussion, the switched capacitor converter is shown as a two phase switched capacitor converter similar to that of FIGS. 4A and 4B. As with the switched capacitor converter of FIGS. 4A and 4B, the switched capacitor converter of FIGS. 5A and 5B a first capacitor 511 and a second capacitor 515 are coupled in series, with the first capacitor coupled to the current source, and the second capacitor coupled to ground. An output of the switched capacitor converter is taken from a node between the first and second capacitors. During the first phase of operation shown in FIG. 5A, a third capacitor 513 is coupled in parallel to the first capacitor. During the second phase of operation, shown in FIG. 5B, the third capacitor, through operation of switches (not shown), is coupled to in parallel to the second capacitor.

The embodiment of FIGS. 5A and 5B, however, includes a further capacitor 517. The further capacitor is in series with the third capacitor, in both the first and second phases of operation. A voltage of Vy is maintained across the further capacitor, resulting in output voltage of the switched capacitor converter being Vnom/2−Vy, instead of Vnom/2 as discussed with respect to the embodiment of FIGS. 4A and 4B. The embodiment of FIGS. 5A and 5B, therefore, allows for an output regulated voltage other than a ratio of Vnom, and allows the current source to be operated in an expected to be optimum manner for conversion efficiency, with a voltage output at Vnom.

In general, regulation of voltage across the further capacitor may be performed in a variety of manners, and independent of power conversion operations of the transimpedance regulator in some embodiments. FIG. 5C illustrates one example way to maintain voltage across the further capacitor at a voltage Vy, with voltage across the further capacitor regulated to Vy during the first phase of operation. This is shown diagrammatically in FIG. 5C with the further capacitor coupled to a differential amplifier 523 provided a voltage Vy as a reference voltage at one input and negative feedback from its output at a second input.

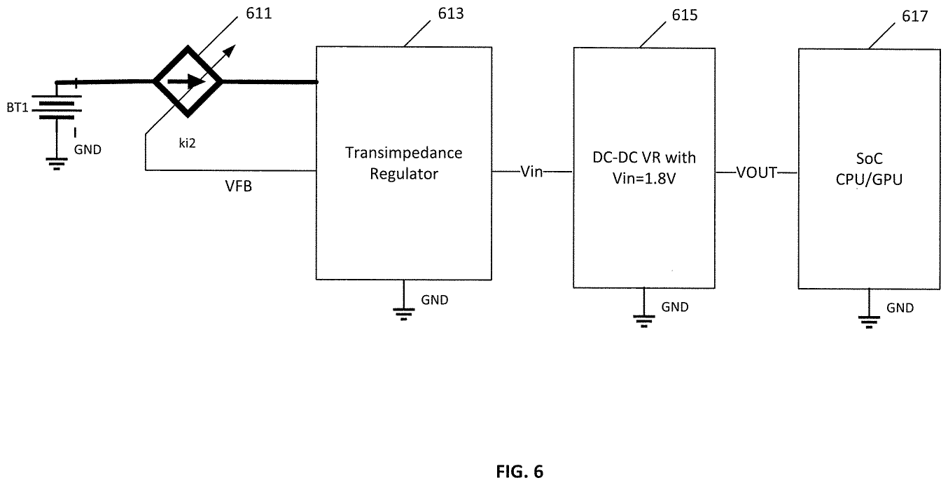

FIG. 6 is a block diagram of a further voltage regulation system in accordance with aspects of the invention. The embodiment of FIG. 6 includes a voltage controlled current source 611 providing current to a transimpedance regulator 613, as discussed with respect to the other figures. In addition, output of the transimpedance regulator is provided to a further voltage regulator 615. The further voltage regulator may be, for example, a DC-DC switching regulator having a buck configuration. Output of the further regulator is provided as power to a load 617, for example an SoC CPU or GPU. In some embodiments the further voltage regulator may be an embedded voltage regulator, on-chip with the CPU or GPU.

Use of the further voltage regulator additionally allows for an inductive component current source to be at operated in an expected to be optimum manner for conversion efficiency, with a voltage output at Vnom, and to do so over a wide range of input supply conditions. Moreover, use of the current source/transimpedance regulator with the further voltage regulator allows for use of the further voltage regulator over a wide range of input supply voltages. For example, an input voltage level for the further regulator may be constrained to be in a 1.6V to 2.0V range, while available battery sources may provide voltage levels of 4V or 12V. In such instances, the transimpedance regulator (and to an extent the inductive component current source), may step down voltages from the battery power source to levels usable by the further regulators.

Although the invention has been discussed with respect to various embodiments, it should be recognized that the invention comprises the novel and non-obvious claims supported by this disclosure.

What is claimed is:

1. A DC-DC converter, comprising:
a current source, and
a transimpedance regulator coupled to an output of the current source.

2. The DC-DC converter of claim 1, wherein the current source comprises a switching converter with an inductive component, and the transimpedance regulator comprises a switched capacitor converter.

3. The DC-DC converter of claim 2, wherein the switching converter with an inductive component comprises a high side switch and a low side switch coupled in series between an input voltage and a lower voltage, an inductor having a first end coupled to a node between the high side switch and the low side switch and having a second end coupled to the switched capacitor converter, and a controller configured to operate the high side switch and the low side switch based on a comparison of a voltage feedback signal from the switched capacitor converter and a reference voltage, the reference voltage being an output voltage of the switching converter with the inductive component expected to yield highest conversion efficiency for the switching converter with the inductive component.

4. The DC-DC converter of claim 3, wherein the switching converter with the inductive component is expected to have a highest conversion efficiency with a 50% switching duty cycle.

5. The DC-DC converter of claim 3, wherein the switched capacitor converter comprises a multi-phase switched capacitor converter.

6. The DC-DC converter of claim 3, further comprising a differential amplifier coupled to a one of the capacitors of the switched capacitor converter, the differential amplifier configured to maintain a predetermined voltage across the one of the capacitors of the switched capacitor converter.

7. The DC-DC converter of claim 3, further comprising a further voltage regulator coupled to an output of the switched capacitor converter.

8. The DC-DC converter of claim 7, wherein the further voltage regulator comprises a DC-DC switching regulator having a buck configuration.

9. The DC-DC converter of claim 8, wherein the further voltage regulator has an output for providing power to a load.
